(19) United States
(12) Patent Application Publication
(10) Pub. No.: US 2010/0293064 A1
(43) Pub. Date: Nov. 18, 2010

(54) SYSTEM AND METHOD FOR DISPLAYING DIGITAL CONTENT

(76) Inventors: SHAWN B. GENTRY, DALLAS, TX (US); KEVIN MOWRY, IRVING, TX (US); VIREN BALAR, MURPHY, TX (US); RAYMOND HOWARD, IRVING, TX (US); JACK BAUM, DALLAS, TX (US)

Correspondence Address: MCKEE, VOORHEES & SEASE, P.L.C., 801 GRAND AVENUE, SUITE 3200, DES MOINES, IA, 50309-2721, US

(21) Appl. No.: 12/779,097

(22) Filed: May 13, 2010

Related U.S. Application Data
(60) Provisional application No. 61/178,805, filed on May 15, 2009.

(51) Int. Cl. G06Q 50/00; G06Q 30/00; G06F 17/30

(52) U.S. Cl. 705/16; 705/1.1; 707/741; 707/E17.002

(57) ABSTRACT

A data processing system is provided for determining specific digital content for displaying on a restaurant table top display unit corresponding to a specific time point of a consumption cycle. In particular, the said data processing system is provided for recording inputs and their associated time stamps from a table top unit, reading a current time from a digital clock, performing calculations on the said inputs, time stamps, and the current time, based on a predetermined algorithm, producing a calculated index; storing a plural of digital contents tagged with tagging indexes; selecting specific digital content with its associated tagging index matching said calculated index for displaying on a signage unit.

### CROSS-REFERENCE TO RELATED APPLICATIONS

This application claims priority under 35 U.S.C. §119 of a provisional application Ser. No. 61/178,805 filed May 16, 2009, and which application is hereby incorporated by reference in its entirety.

### FIELD OF THE INVENTION

The invention relates generally to restaurant tabletop display devices and more particularly to systems and methods for controlling digital content displayed on the devices.

### BACKGROUND OF THE INVENTION

Some sit-down restaurants provide tabletop display devices. These tabletop display devices include a display screen for displaying digital content, such as advertisements, menu selections, news, entertainment shows, or games. These tabletop devices may also include input devices, such as touch screens, or separate keyboards. Preferably they will also include provisions for presenting the patrons with a bill, and accepting credit or debit card payment.

A tabletop unit and system is available from TableTop Media of Dallas, Tex.

Additional examples are also shown in pending U.S. patent application Ser. Nos. 11/190,565; 11/456,151; 11/695,218; 12/028,244; 12/141,744; and 12/197,456 all of which are incorporated in their entirety herein by reference. The present invention relates to an improvement to the control of content displayed on the display units.

### BRIEF SUMMARY OF THE INVENTION

The present invention relates to an improvement in our current system and to a method for determining specific digital content for displaying on a tabletop display unit, corresponding to a specific time during a food consumption cycle. The content of the tabletop display will vary to match the stage of the dining experience. For example, during an initial stage, immediately after the patrons are seated, the display unit might show advertisements and descriptions of appetizers and beverages. During the stage after the order has been submitted, but before the food has come, the display screen might be devoted to games, news, entertainment, or general advertising. Some period of time after the main courses have been served, the display might be switched to advertisements for desserts. In this fashion, the display on the tabletop device is coordinated with the dining experience to improve the enjoyment of the patrons, to improve the impact of the advertisements and other displays, and to improve the overall efficiency of the restaurant.

### BRIEF DESCRIPTION OF THE DRAWINGS

FIG. 1 is a schematic diagram of the components of a system according to one or more aspects of the present invention.

FIG. 2 is an exemplary illustration of specific dining stages and dining stage specific digital content.

### DETAILED DESCRIPTION OF THE PREFERRED EMBODIMENT

To the accomplishment of the foregoing and related ends, the following description and annexed drawings set forth in detail certain illustrative aspects and implementations of the invention. These are indicative of but a few of the various ways in which one or more aspects of the present invention may be employed. Other aspects, advantages and novel features of the invention will become apparent from the following detailed description of the invention when considered in conjunction with the annexed drawings.

One or more aspects of the present invention are described with reference to the drawings, wherein like reference numerals are generally utilized to refer to like elements throughout. In the following description, for purposes of explanation, numerous specific details are set forth in order to provide a thorough understanding of one or more aspects of the present invention. It may be evident, however, to one skilled in the art that one or more aspects of the present invention may be practiced with a lesser degree of these specific details. In other instances, known structures and devices are shown in block diagram form in order to facilitate describing one or more aspects of the present invention.

According to one embodiment of the invention, the selection and timing of content is controlled by a start time for the dining experience. Upon initiation of the sequence by a diner or host touching the display screen, a sequentially staged display of content is provided on the display unit. As time lapses after the initiation of the program, the program cycles through sequential stages. The content displayed on the display unit is dependent upon which stage corresponds with the time elapsed after the initiation of the program. Thus, the guest can touch the screen to start a new dining experience and begin the timed delivery of content linked to specific stages of the dining cycle.

According to another embodiment, the system is integrated with the point of sale and kitchen display systems to deliver digital content dependent upon receiving signals from the point of sale (POS) and kitchen. For example, the content would change to a new stage upon the entry of an order at the point of sale, and would roll to another stage upon a signal from the kitchen that the food has come out.

One other embodiment provides a data processing system for determining specific advertisements with a specific set of menu items to be sent to a signage displaying unit at specific dining stages. The signage displaying unit can be a table top unit situated on a dining table with diner(s) as the user(s) providing inputs through interaction with the table top unit by means of touching the screen. The data processing system can improve effectiveness of the advertisements by displaying certain digital content at a certain time point during the dining, for instance, an advertisement of dessert menu item has more impact after the time when the main dish has been served and before the time any desert has been ordered, than other time point.

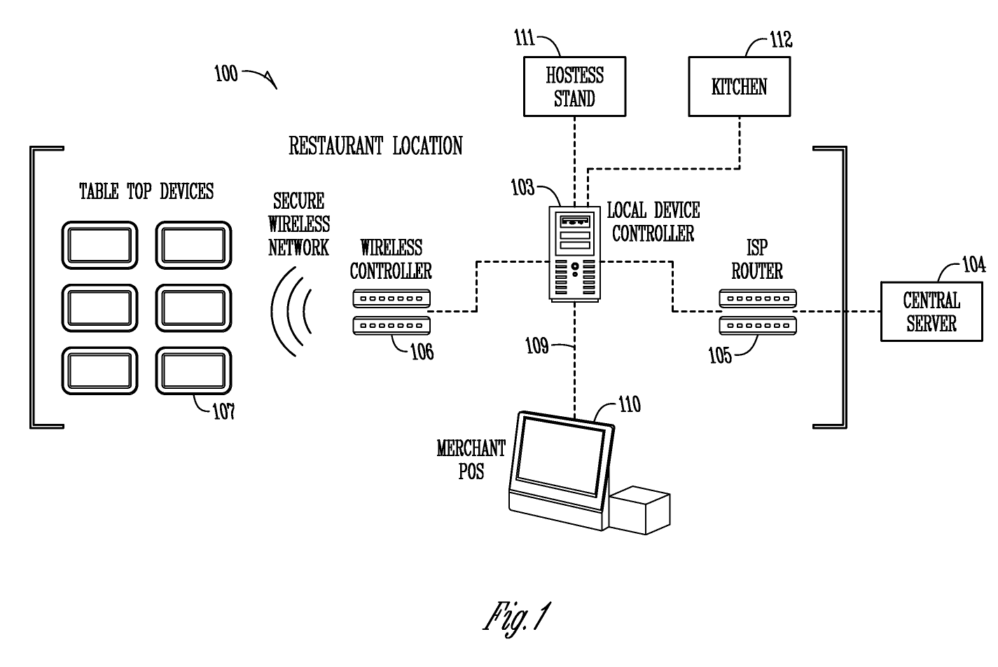

The present invention pertains generally to a system of controlling the display of digital content on a tabletop display unit. FIG. 1 is a schematic diagram of an exemplary digital system for displaying digital content in a restaurant. According to FIG. 1, a digital system 100 comprising various components is illustrated and hereinafter described in accordance with one or more aspects of the present invention. According to one aspect of the invention, system 100 primarily includes server computer 103, a plurality of apparatuses 107, and communication link 106. According to another aspect of the invention, system 100 further includes communication link 109 to the restaurant's existing POS system 110. In an exemplary implementation of system 100, the communication links 106 comprise wireless links. According to yet another aspect of the invention, system 100 further includes central server computer 104, and network link 105. According to yet another aspect of the present invention, the central server computer 104 is capable of down loading control programs and/or data into server computer 103 and server computer 103 is capable of downloading control programs and/or data into apparatus 107. According to yet another aspect of the present invention, the apparatus 107 is capable of uploading information to the server computer 103 and then to the central server 104. The operation of the system 100 can be better understood after the methodologies of processing restaurant transactions according to the invention are described.

According to some embodiments the system 100 may also include a hostess stand computer 111 that is connected with the server computer 103 as well as a kitchen computer 112 that is linked to the server computer 103.

The system 100 in FIG. 1 can be used to control the display of digital content on the table top devices 107 according to one aspect of the present invention. It can also show video content if desired. The table top devices 107 are preferably of the types that have a touch screen for displaying digital content, and for receiving input from a user, such as a diner, by touching the screen. Preferably the table top devices 107 will be provided with pay-at-the-table technology that permits a patron to view their bill and pay the bill on the device 107. According to some embodiments it may also be possible for a diner to order their food, request attention from a server, and control the content displayed on the device.

The table top devices 107 are connected to the local server 103, which is a computer processor. The link between the table top devices 107 and the computer 103 is preferably a wireless connection. The wireless connection 106 permits information and input to be transmitted back and forth between the computer 103 and the devices 107. In a similar fashion, the hostess stand computer 111 is also linked with the computer 103 either by wireless connection, or other known technology, such as hard wiring. The kitchen computer 112 is also connected with the local controller 103 as is the point of sale computer 110. The local controller 103 may be but is not necessarily connected to an external server 104 via an Internet service provider router 105. Several such systems 100 may be connected to a single central server 104.

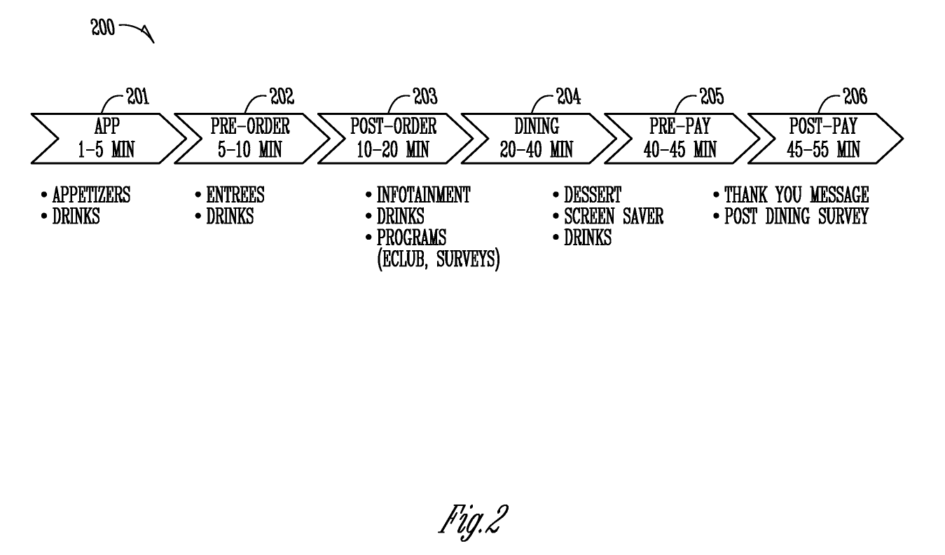

In operation, a patron may be seated at a table that has a table top device 107. Upon being seated, the patron may initiate a display program by touching the display screen. The display screen will then show various digital content depending on the elapsed time after the initiation. According to one embodiment, the time after initiation is broken down into stages of predetermined length, and the digital content displayed on the screen is selected according to the then-current stage. For example, with reference to FIG. 2, a digital content display program 200 is illustrated in schematic form. The display program 200 includes six stages: an appetizer stage 201, a pre-order stage 202, a post-order stage 203, a dining stage 204, a pre-pay stage 205, and a post-pay or dining end stage 206. The stages are set to predetermined lengths of time, depending on an average or expected dining cycle. For example, the appetizer stage 201 may be set for the first five minutes after initiation. During this appetizer stage 201, the digital content displayed on the screen will preferably relate to advertisements and descriptions of appetizers and drinks that the diners might wish to order. During this appetizer stage 201 the local controller 103 will select only digital content that is tagged with an identifier that is appropriate for the appetizer stage to send for display on the device 107. After five minutes have elapsed, the appetizer stage 201 ends and the pre-order stage 202 begins. During the pre-order stage 202, the controller 103 will select only digital content files that have been indexed as appropriate for the pre-order stage 202. For example, during the pre-order stage, the display on the table top device 107 may display advertisements and descriptions of entrees and beverages that the diners may wish to order. When the time has cycled to the end of the pre-order stage 202, the post-order stage 203 begins and the local controller 103 will select only that digital content that has been indexed as appropriate for the post-order stage 203 to appear on the table top devices 107. The content of the post-order stage 203 digital content will likely include entertaining features such as games or motion pictures; it may also include ads and information relating to a variety of other topics, or may include a survey such as a survey related to customer satisfaction. During the dining stage, the digital content may be selected to advertise desserts or after dinner drinks. During the pre-pay stage 205, the content may be selected to display the bill, and provide options for dividing the bill, such as separate checks by items orders, or divided equally, or by dollar amount. During the post-pay or stage 206 the digital content may be selected to include a Thank You message, a post-dining survey, or other contents selected by the restaurant.

The dining stage clock can be started by the patron himself, or by restaurant staff (such as waiter or waitress) touching the display screen. As well the table management system (located at the hostess stand) can be integrated with the table top device 107, and the system can be activated as the hostess is seating guests. The system once actuated can move from stage to stage by timed initiation, customer initiation or restaurant host or hostess or waiter initiation. If desired for example the customer could start it by swiping a card or a sensor could sense the seating of a customer and start the sequence.

The tabletop system or device 107 may, if desired, have the ability to query the point of sale to determine what menu items were ordered by the customer and then serve promotions/content/ads based on the item(s) ordered or currently being consumed. For example, if someone ordered a Bud Light brand of beer, it has the ability to know this and then serve a particular ad that's more relevant to the user; such as, “Ready for another Bud Light?” or could sell an ad to their competitor that says, “Mr. Bud Light drinker, find out why many says Coors Light is better.” This is just one of many configurations where the more relevant ad could drive another round by communicating directly to the user in a relevant manner or try to switch the user to try another brand.

In another configuration, an ad could be delivered at a particular moment, such as 11 minutes after the user is served a beer; for example, if the average guest consumes a beer in 13 minutes, one could get that promotional message in front of the guest at the most optimal point in time (at the point of decision).

Those or ordinary skill in the art will understand that fewer or greater number of stages may also be used. Those skilled in the art will also be aware of additional appropriate content to be associated with the various stages.

According to another embodiment, the transition between stages may be based upon additional actions or input from the table top devices 107, rather than strictly based upon time lapsed. For example, if the table top device 107 is equipped to permit the diners to place their food orders at the table through the device 107, the transition from the pre-order stage 202 to the post-order stage 203 might be triggered by the entry of the order, rather than by passage of time. In that fashion, the digital content may be selected to even more closely track the stage of the dining cycle than an estimated or average time. Similarly, the server could provide input at the table top device 107 upon bringing the food to the table to transition from the post-order stage 203 to the dining stage 204. The diners could initiate the pre-pay stage 205 by making indication on the touch screen of the device 107 that they are ready to pay the bill. Similarly, the transition from the pre-pay stage to the post-pay stage might be triggered by the submission of a payment through the table top device 107.

The triggers for transitioning between stages may also be activated by devices other than the table top devices 107. For example, if the hostess stand computer 111 is linked with the local control device 103, the hostess may initiate the initial program upon the seating of the patrons. The hostess stand computer 111 may also be used to trigger the transition between other stages, or may be used to override scheduled transitions. For example, if the post-order stage 203 is generally set for ten minutes, but it is an extremely busy time and the hostess is aware that it will take more than ten minutes for the food to arrive, the hostess may be able to extend the time of the post-order stage 203 to override the automatic transition to the dining stage 204. The link with the control 203 may also permit the hostess stand computer 111 to display information regarding the stage of a particular table top device 107 so that the hostess is aware of what stage of the meal cycle those diners are in. This can permit for better planning by the hostess regarding expected wait times and table availability.

The transition between stages may also be triggered by the kitchen computer 112. Therefore when the kitchen receives an order it may update the status to change stages, and when the kitchen has completed an order it may also trigger a transition between stages. The kitchen computer 112 may also include a display showing the status of various table top devices 107 so that the kitchen staff is aware of what stages the various tables are. The point of sale computer 110 may also be used to trigger the various stages. Therefore, when a waiter or waitress enters the appetizer or drink orders, the point of sale computer 110 will signal the control device 103 via link 109 to transition from the appetizer 201 to the pre-order stage 202. Once the waiter or waitress enters the entrée order, the point of sale computer 110 will provide a signal to the controller 103 to transition from the pre-order stage 202 to the post-order stage 203.

The controller 103 may be a computer, such as a personal computer or server, that includes a computer processor. The control device 103 may also include its own internal memory that may be a hard drive, or it may be provided with access to other storage media such as CDs, DVDs, memory sticks, flash drives, or connection to other external storage media, such as external servers that can be accessed via internal or external networks, such as the Internet. The computer processor of the control device 103 is programmed to perform the steps needed to carry out the proposed invention. The storage media to which the controller 103 has access should include sets of digital content that can be activated by the processor for display on the table top devices 107. The digital content should be provided with a tagging index or indices, to indicate the stages that are appropriate for that content to be displayed. The local controller 103 may have an internal clock, or may have access to an external clock.

The central server 104 may be a server computer located remotely from the restaurant. It may be appropriately programmed to provide content and instructions to numerous local restaurants. Alternatively, it may be possible to include all of the necessary programming on the central server 104, such that the local controller 103 is not needed, but all of the control processes are carried out by the central server 104.

Although the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature or aspect of the invention may have been disclosed with respect to only one of several implementations, such feature or aspect may be combined with one or more other features or aspects of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.” Also, the term “exemplary” is merely meant to mean an example. It is also to be appreciated that layers and/or elements depicted herein are illustrated with particular dimensions relative to one another (e.g., components dimensions and/or orientations) for purposes of simplicity and ease of understanding, and that alterations for example in the dining stage breakdown may be made, with the key being to time the displays with the customer's stage of meal consumption to maximize the affect of the display on purchases.

What is claimed is:

1. A system for controlling digital content on a tabletop display, the system comprising:
a tabletop unit having a display screen and an input mechanism;
a digital storage medium programmed to include a plurality of digital content files that can be accessed by the tabletop unit to provide a display on the display screen; and
a computer processor associated with the tabletop unit and programmed to provide selected ones of the plurality of digital content files to the tabletop unit based on timing of the stages of a customer dining experience.

2. The system of claim 1, wherein at least one of the digital content files is associated with at least one of a plurality of index tags, wherein the plurality of index tags correspond with stages of a dining consumption cycle, and wherein the computer processor is programmed to provided the selected ones to the tabletop unit based on a matching of the index tags with the stages of a then-current dining consumption cycle.

3. The process of claim 1 wherein the system moves from stage to stage by activation triggered by either the restaurant personnel or the customer.

4. The system of claim 2, further comprising a first input device remote from the tabletop unit programmed to provide input to the computer processor to change the stage of the then-current dining consumption cycle.

5. The system of claim 2, wherein the first input device is a point of sale device.

6. The system of claim 4, further comprising a second input device remote from the tabletop unit programmed to provide input to the computer processor to change the stage of the then-current consumption cycle.

7. The system of claim 6, wherein the second input device is located in a restaurant kitchen.

8. A method of displaying digital content comprising:
providing a tabletop display unit that includes a display screen and an input mechanism;
receiving an indication that a dining consumption cycle has begun from the input mechanism; and
initiating a display of a plurality of digital content files on the display screen after receiving the indication, the content of the display being dependent upon the stage of the dining experience.

9. The method of claim 8, further comprising:
defining stages of a dining consumption cycle;
indexing each of the digital content files in the plurality of digital content files with at least on of the stages; and
displaying digital content files on the display screen if and only if they have an index that matches a then-current stage of the dining consumption cycle.

10. A method of displaying information in a sitdown restaurant on a tabletop display of the type having a touchscreen and a payment receiving mechanism, the method comprising synchronizing the content displayed on the screen with the stages of a dining consumption cycle.

11. The method of claim 10, wherein the synchronization is based on elapsed time after the dining consumption cycle has begun.

12. The method of claim 10, wherein the synchronization is based on dining stage milestones that occur.

13. A data processing system for determining specific digital content to display on a signage displaying unit at a specific time point, comprising:
computer processor means for processing data;
storage means for storing data on a storage medium;
first means for storing a plural sets of digital content each tagged with a specific tagging index;
second means for receiving and storing specific input and associated time stamp;
third means for reading current time from a digital clock;
fourth means for performing calculation using the said specific input and associated time stamp and current time for providing a calculated index;
fifth means for selecting a specific set of digital content for sending to and displaying on the said signage displaying unit using the said calculated index from the said plural sets of digital content at a specific time;

14. A data processing system as claimed in claim 13, wherein the first means further comprises:
means for inputting set of digital content;
means for assigning a tagging index to the said set of digital content;
means for assigning a set of display attribute tags to the said set of digital content describing how the said digital content to be displayed on a signage displaying unit;
means for storing the said set of digital content associated with the said assigned tagging index and the assigned set of display attribute tags;
means for deleting a specific set of digital content;

15. A data processing system as claimed in claim 13, wherein the second means further comprises:
means for translating interaction of the diner with a table top unit into a specific input;
means for assigning a time stamp to the said specific input;
means for retrieving the said specific input and the assigned time stamp from the said table top unit;
means for storing the said retrieved said specific input and the said assigned time stamp on a storage medium;

16. A data processing system as claimed in claim 13, wherein the fourth means further comprises:
means for inputting algorithm used for the said performing of calculations;
means for inputting configuration data for the said algorithm;
means for changing the said algorithm as needed;
means for changing the said configuration data as needed;

17. A data processing system as claimed in claim 13, wherein the fifth means further comprises:
means for calculating the extent of matching between the said calculated index and the tagging index associated with a specific set of digital content;
means for selecting one or more sets of digital content associated with the tagging index having the most extent of matching with the said calculated index;
means for sending the said selected one or more sets of digital content to a signage displaying unit;
means for sending command to the said signage displaying unit wherein the said command causes the said signage displaying unit to
(a) delete certain set of digital content from its displaying queue, or;
(b) change order of digital contents on its displaying queue.

18. A data processing system as claimed in claim 12, wherein the said translating interaction of the diner with a table top unit into a specific input comprises translating diner interaction with the table top unit into the following inputs:
(a) dining start
(b) appetizer ordered
(c) main dish ordered
(d) main dish served
(e) check requested
(f) payment rendered
(f) dining end
the said assigning time stamp comprises assigning time stamp representing the time read from a digital clock when the diner interaction with the table top unit occurred.

19. A data processing system as claimed in claim 18, wherein fourth means for performing calculation comprises:
comparing the current time with the input with the time stamp representing the latest time before the current time;
the calculated index will be determined according to the following algorithm:
(a) if the input is “dining start”, then the calculated index is “app”
(b) if the input is “appetizer ordered”, then the calculated index is “pre-order”
(c) if the input is “main dish ordered”, then the calculated index is “post-order”
(d) if the input is “main dish served”, then the calculated index is “dining”
(e) if the input is “check requested”, then the calculated index is “pre-pay”
(f) if the input is “payment rendered”, then the calculated index is “post-pay”
(g) all other case, then the calculated index is “inactive”

20. A data processing system as claimed in claim 19, wherein first means for storing a plural sets of digital content each tagged with a specific tagging index comprises:
storing sets of digital content with one of the following specific tagging indexes:
(a) start of the dining experience stage;
(b) appetizer and drink order stage;
(c) post order stage;
(d) dining stage;
(e) pre-pay stage;
(f) post-pay stage; and
(g) ending stage,
wherein fifth means for selecting a specific set of digital content comprises:
selecting the set of digital content with a tagging index matching the calculated index.
